(19) United States
(12) Patent Application Publication
(10) Pub. No.: US 2025/0252566 A1
(43) Pub. Date: Aug. 7, 2025

(54) METHOD FOR PROCESSING A RECORDED VIDEO DATA STREAM, IMAGE RECORDING METHOD FOR GENERATING A VIDEO DATA STREAM, AND ASSOCIATED VISUALIZATION SYSTEM

(71) Applicant: Schölly Fiberoptic GmbH, Denzlingen (DE)

(72) Inventors: Sébastien WEITBRUCH, Niedereschach (DE); Andreas HILLE, Villingen-Schwenningen (DE)

(73) Assignee: Schölly Fiberoptic GmbH, Denzlingen (DE)

(21) Appl. No.: 19/037,540

(22) Filed: Jan. 27, 2025

(30) Foreign Application Priority Data
Feb. 7, 2024 (DE) 102024103430.0

(51) Int. Cl. G06T 7/00; G06T 5/20; G06T 5/94; G06T 7/90

(52) U.S. Cl. CPC G06T 7/0012; G06T 5/20; G06T 5/94; G06T 7/90; G06T 2207/10016; G06T 2207/10024; G06T 2207/10064; G06T 2207/30016; G06T 2207/30096

(57) ABSTRACT

In a method for processing a video data stream recorded by a sensor, in particular an image sensor, by a filter provision applicable to the video data stream, which is stored with respect to a spectrally limited light, it is provided that unsegmented further video data streams, in particular a first video data stream and a second video data stream, be generated from the recorded video data stream, with the spectrally limited light being amplified or reduced in the first and second video data streams in relation to a background due to the filter provision. A visualization system configured to carry out the method is also provided.

### CROSS-REFERENCE TO RELATED APPLICATIONS

This application claims priority from German Patent Application No. 10 2024 103 430.0, filed Feb. 7, 2024, which is incorporated herein by reference as if fully set forth.

### TECHNICAL FIELD

The invention relates to an image processing method for processing a video data stream recorded by a sensor, in particular an image sensor, wherein a filter provision applicable to the video data stream with respect to spectrally limited light is stored.

The invention furthermore relates to an image recording method for generating a video data stream using a sensor, in particular an image sensor, in an image processing method.

The invention moreover relates to a video data stream generation stage, thus a device for generating a video data stream and a visualization system, which can comprise a microscope or an endoscope, for example.

### BACKGROUND

Using complex image processing methods when separate video data streams are recorded, typically using multiple sensors, which sensorially acquire different components of an overall light spectrum reflected and/or emitted by an object, is already known from practice.

Fluorescence imaging (FI) is an advanced imaging technology in this context, which enables more information to be obtained from an image than the human eye is capable of. To achieve this, a specific light spectrum (for example in the IR or UV wavelength range) is guided as excitation light onto a scene, wherein the excitation light interacts with a fluorophore in the scene, which is intercalated, for example, in certain tissue types, which then upon the optical excitation emit a light spectrum deviating from the excitation light as fluorescent light, which is to be sensorially acquired in a location-resolved manner using a camera. The excitation light is kept away from the image sensor in this case by means of an excitation light filter (typically installed in the camera), so that only visible illumination light and the fluorescent light are sensorially acquired. The acquisition of the fluorescent light can supply augmented information, which can be displayed alone or together with the expected “visual content”, often in the form of white light imaging (WLI).

### SUMMARY

Proceeding therefrom, the invention is based on the object of enabling imaging in application situations as described above using only a single image sensor, which provides different spectral information in the form of separate video data streams. The requirements for the hardware are to be kept as low as possible for this purpose.

The aim of the present invention in this case is, inter alia, to enable the extraction of fluorescent light image information as described above from a video data stream obtained using a single image sensor with better signal quality and at the same time to separate the signal components of the fluorescent light from those signal components which are based on non-fluorescent light that can be acquired and/or detected (this nonfluorescent light can in particular be in the visible wavelength spectrum (VIS)). According to the invention, for this purpose different optical (video) channels (“channel separation” for visible versus fluorescent wavelengths, for example) are to be generated from the video image data stream recorded using the image sensor.

A typical application of the method according to the invention would be, for example, imaging using 5-ALA (5-aminolevulinic acid) as fluorophore. This fluorescent chemical marker is already used in clinical practice in order to make malignant tumor cells in the brain visible during an operation. Malignant tumors often grow in an invasive and infiltrating manner, meaning that the edges of the tumor often cannot be distinguished from the surrounding healthy tissue by the surgeon. 5-ALA is therefore excited by a special blue light having a wavelength of 440 nanometers (excitation light), in order to thus cause the tumor cells to luminescence. Tumor cells which are not visible to the naked eye can therefore first be recognized under irradiation using the excitation light and subsequently removed precisely. This method thus helps to improve the result of a tissue resection in the brain and therefore the operation result. At the same time, however, the entire operation region, illuminated by visible illumination light, is to be visualized to the surgeon by means of white light imaging, specifically using the same image sensor which is also used for the fluorescent light imaging.

One or more of the features disclosed herein are provided according to the invention to achieve the mentioned object. In particular, to achieve the stated object in an image processing method for processing a video data stream recorded by a sensor, in particular an image sensor, it is therefore proposed according to the invention that a first video data stream is generated using the filter provision from the recorded video data stream, in which an effect that can be generated by the spectrally limited light is reduced in relation to an image background, and that a second video data stream is generated from the recorded video data stream using the filter provision, in which the effect that can be generated by the spectrally limited light is amplified in relation to the image background.

In other words, two separate video data streams are therefore generated by applying the stored filter provision to the video data stream recorded by the sensor. Each of these two video data streams corresponds here to a separate (video) channel or forms such a (video) channel. While in the second channel, the effect generated by the spectrally limited light is visualized, the first channel visualizes the image background, thus that image information which would also still be present if the currently observed scene were not illuminated using excitation light. This image background can thus exclusively be based on reflected (in particular visible) illumination light, but not on emitted fluorescent light. Each of the two video data streams can be extracted unsegmented from the original video data stream by means of image processing, so that the respective generated first and second video data stream shows the entire scene in each case, which is observed using the visualization system employed in the method and/or is sensorially acquired using the (single) image sensor.

In the approach according to the invention, both spectra—the visible wavelengths of the illumination light and the (typically invisible) fluorescent light—are thus recorded chronologically and spatially together using only one single image sensor. In particular no chronological separation (for example by alternating illumination) and also no spatial separation (for example by spectral splitters and two spatially separated image sensors) of the fluorescent light and the white light takes place (primary channel for white light imaging, secondary channel for fluorescent light imaging), as is the case in previously known approaches.

The advantages of the approach according to the invention are obvious in this case: lower costs for hardware and higher possible image rates, wherein the latter enables a good resolution of movements. The invention is additionally also usable when the fluorescent wavelengths are in the visible range, which then generally makes a classic spatial separation by means of beam splitters impossible.

The invention offers a cost-effective solution for a variety of areas of application, wherein the achieved improvement of the image quality is accompanied in particular in the case of fluorescence imaging with low demands on the electronic design, since the solution according to the invention operates in a simple and resource-conserving manner (with respect to the image processing algorithm used).

The separation of the two optical channels for the white light imaging and the fluorescence imaging is based according to the invention solely on image processing or solely on image signal analysis. Therefore, however, under certain circumstances a 100% selectivity cannot always be achieved, meaning that the distinction between real fluorescence signal and nonfluorescent signal can be less precise than with more expensive solutions which are already available on the market. However, this is less problematic for numerous applications.

In other words, the invention therefore proposes that on the basis of the filter provision, by means of image processing of an original video data stream recorded using the (single) image sensor, a first video data stream which visualizes the original video data stream, as if an excitation light were switched off (thus, for example, a white light image on which a fluorescent light component is removed), is derived and that furthermore a second video data stream is derived from the original video data stream, which visualizes an effect of the excitation light, for example a fluorescent light component based on the excitation light. The invention enables both video data streams generated in this manner to be separated solely using image processing means and thus two separate (video) channels to be created, without completely losing the image information in the respective other channel, however, which is decisive for the other (video) channel.

According to the invention, a separation of the recorded video data stream into the first video data stream and the second video data stream can particularly advantageously be carried out by the filter provision using only a single image sensor. A spatial or chronological separation and therefore multiple image sensors or a chronologically alternating illumination therefore becomes superfluous (even if the method can fundamentally also be employed if multiple image sensors and/or an alternating illumination is used). Therefore, a chronologically constant illumination with excitation light can also be used in the method in order to continuously generate the spectrally limited light (for example fluorescent light).

The effect generated by the spectrally limited light can be, for example, that the spectrally limited light generates a corresponding image signal (in particular a fluorescent light image signal) on the image sensor. Such a signal can be recognizable on the recorded video data stream by means of chromatic pixels of the image sensor (which is therefore designed as a color image sensor). The image background can be, for example, achromatic here, for example when white light images are generated as monochromatic black and white images with the aid of the first video data stream. Said image background can thus be understood here in particular as all of the image information which is generated by wavelengths lying outside the spectral range of the spectrally limited light. If the spectrally limited light is, for example, fluorescent light at a red visible fluorescent wavelength, the image background can thus visualize all visible wavelengths with the exception of the signal component of the visible fluorescent wavelength.

The spectrally limited light can be, for example, a fluorescent light here, which is in particular emitted from a fluorescent light area due to an excitation light, for example infrared (IR) light, ultraviolet (UV) light, from an observed scene and is recorded by the sensor. It can therefore be provided, for example, that the spectrally limited light is in particular based on an excitation light and/or an optical interaction. For example, the excitation light can interact with a contrast agent, in particular with a fluorophore, by which the spectrally limited light is then emitted.

The first video data stream, in which the effect generated by the spectrally limited light in relation to the image background is reduced due to the filter provision, can be, for example, a white light image of the recorded video data stream. The effect, which is amplified in the second video data stream in relation to the image background and is generated by the spectrally limited light, can be, for example, a fluorescent light image (spectral image). Such a fluorescent light image can be used, for example, to display/visualize image areas in which the fluorescence is to be observed.

Therefore, for example, the recorded video data stream can particularly advantageously be split into the two video data streams, without image information of the recorded video data stream being lost in one of the two video data streams, since this image information is decisive for the respective other video data stream (cf. below).

It is furthermore advantageous that the respective image information recorded by the sensor can be extracted, for example, via the two video data streams so that fluorescent light areas (i.e. image areas in which a fluorescence is observed) of the recorded video data stream can be separately processed and/or separately displayed. An extraction can take place here, for example, for each pixel of the image sensor or for local areas of groups of pixels of the image sensor (such as 2×2 pixels).

The image sensor can be, for example, a color image sensor having multiple color channels (R, G, B). In this way, all color channels of the color image sensor can be taken into consideration both in the generation of the first video data stream and in the generation of the second video image data stream. It can be provided here, for example, that the components of the filter provision, which are each applied to the first or the second video data stream, are defined via (respective, different) algorithms.

The filter provision can therefore be initially defined, for example, via a fundamental extraction/separation of fluorescence images. When the filter provision is applied, signal components can therefore be separated from the originally recorded video data stream which are/were generated by the spectrally limited light. It can be provided here, for example, that initially, for each pixel, a maximum value and a minimum value for each color component/each color channel of the image sensor used (with an RGB sensor therefore, for example, the maximum and minimum value of each of the three color components R, G, B) is calculated for each pixel of the image sensor or for local groups of pixels of the image sensor (=local signal minima and maxima).

In other words, the invention therefore in particular proposes performing the separation of the two video data streams in a location-resolved manner on the basis of a (respective) local dynamic range (max-min), which is ascertained (in each case) in a location-resolved manner from the original video data stream in consideration of signal values of all color channels of the image sensor used. Location-resolved ascertainment can be understood here in particular to mean that for individual image areas/pixel areas or even for individual pixels of the image sensor, a local dynamic range (difference of the signal maxima and minima) is calculated in each case and taken into consideration in the processing of signals from this area. It is decisive in this case that the signal values of at least two, preferably however of all, color channels of the image sensor are incorporated into the calculation of the local dynamic range. In this way, the sensorially acquired image information can be fully used, in order to thus be able to perform an optimum separation, which is locally adapted in each case (in particular pixel by pixel), of the signal components into the two video data streams. Depending on the application, however, it is not absolutely necessary for all color channels to be read out in order to determine the local dynamic range. For example, it can be the case that one of the color channels of the image sensor is not sensitive at all or is only very weakly sensitive for a specific spectral range and therefore does not have to be taken into consideration.

This is because it is often the case in the application that in an observed scene large contrast and/or brightness differences occur and moreover the fluorescent regions of interest are in particular those which are very dark or very noisy or are regions having low contrast. If for example the brightest area of the image were now also incorporated into the calculation, this would be a corruption of the image results in dark areas. The consideration of the local dynamic range thus ensures that an optimum separation of the signal components, which are used for the generation of the second video data stream, can always take place for a specific subregion of the image. In other words, the separation of the signal components into the two video data streams will thus generally vary in a location-dependent manner (depending on the image area). In this way, noise influences and very weak image influences, which only occur locally, can also be taken into consideration. A location-resolved image signal processing/channel separation adapted in each case to the dynamic range can thus be achieved.

The calculation of the signal maxima and minima can be defined, for example, by the following formulas:

Max1_{(x,y)}=Max(R_in_{(x,y)},G_in_{(x,y)},B_in_{(x,y)})

Min1_{(x,y)}=Min(R_in_{(x,y)},G_in_{(x,y)},B_in_{(x,y)})

In this case, (x,y) can designate, for example, a respected local area within the active sensor surface of the image sensor, thus a specific number of pixels or else only a single pixel. The coordinates x, y therefore specify the spatial position of the respective pixel in the image. R, G, B, in contrast, are the individual color channel components of the respective pixel, for example after the debayering.

If, for example, in one of the two video data streams, a spectrally limited light, for example a (visible or invisible) fluorescent light component or a fluorescent light image signal FI_{(x,y)}, is to be filtered out/separated from the recorded video data stream by the filter provision, this can be carried out, for example, by a comparison of the color sought (for example: red) with the maximum differences of the associated color channel components (in the example: R, G, and B; thus all color channels of the color sensor), and specifically in particular in consideration of a correction coefficient (Rate1). In other words, it can thus be provided that the effect generated by the spectrally limited light, in particular a fluorescent light image component “FI”, is calculated out of signal values of a single color channel (R/G/B) of the image sensor by the filter provision. A correction coefficient can be taken into consideration in this calculation. This can specify, for example, which component of the signal value of the color channel or the local dynamic range is to be attributed to the effect/the fluorescent light image component or which (complementary) component is not to be attributed to this effect/is not part of the FI signal (both of these approaches are technically equivalent). Such a component can be ascertained empirically, for example, by experiments for a specific fluorophore such as 5-ALA or by modeling.

The correction coefficient Rate1 is preferably applied globally in this case for a frame/a respective image of the video data stream, thus in particular not in a locally differing manner, like the previously explained local dynamic range. This (global) correction coefficient does not have to be chronologically constant, but rather, for example, exposure data or other image data of the respective frame/individual image can also be incorporated into the calculation. Accordingly, the correction coefficient Rate1 can change chronologically, in particular progressively. The correction coefficient Rate1 can result, for example, from the degree of the coloration of the fluorescence signal in relation to a colorless gray background. This effect can be attributed to specific properties of the image sensor used, which can be deliberately utilized in this way.

Such a value FI (fluorescence imaging), which visualizes the signal components/the generated effect of the spectrally limited light (referred to hereinafter as FI signal or fluorescent light image component), can be calculated by the following (exemplary) formula (here in the example of a red fluorescence wavelength):

$${FI}_{( x , y )} = {R\_in}_{{( x , y )}^{-}} ( Rate 1 * ( Max {1}_{( x , y )} - Min {1}_{( x , y )} )$$

Generally speaking, the invention therefore proposes, in the context of the generation of the second video data stream, calculating the effect generated by the spectrally limited light, thus in particular a fluorescent light image component “FI”, from a single color channel (matching with the respective spectrally limited light, thus, for example “R_in_{(x,y)}” in the case of a red fluorescence wavelength as in the above example) of the image sensor in a location-resolved manner in each case, and preferably in consideration of a respective local dynamic range (Max1_{(x,y)}−Min1_{(x,y)}), which was ascertained from at least two, preferably from at least three, in particular from all color channels (more precisely from the signals of these color channels) of the image sensor (for the respective pixel). The dynamic range relates here as described above to respective signal intensities (in the original video data stream), which the image sensor supplies in the respective color channel for the affected pixel.

For the first video data stream, the filter provision can be defined, for example, via an extraction/separation of signal components which are generated by visible illumination light wavelengths.

It can be provided, for example (in particular if a gray background/a white light image (WLI) is to be generated as a grayscale image of the recorded video data stream), that for each pixel of the image sensor (in particular after execution of a debayering, so that one signal value per color channel used is present for each pixel. Debayering, or demosaicing, is understood as the reconstruction of a color grid graphic from brightness values of an image sensor overlaid with mosaic color filters, in particular an RGB color image sensor) or for respective local areas of groups of pixels of the image sensor (such as 2×2 pixels), a respective image signal component is calculated which corresponds to the signal component of the visible wavelengths incident on the scene as illumination light (with the exception of a possibly present visible fluorescence wavelength). Such an (in particular WLI) image signal component can be formed either directly from the received RGB values of the image sensor or as a difference to an FI signal, for example as a grayscale value. This can be calculated, for example, by the following formula, wherein the previously calculated FI signal is taken into consideration here by the subtraction:

$$Gray {1}_{( x , y )} = [ {G\_in}_{( x , y )} - {FI}_{( x , y )} ] + [ {B\_in}_{( x , y )} - {FI}_{( x , y )} ]$$

As can be seen in the formulas, it can be provided in particular here that the first video data stream is separated from the original video data stream on the basis of signal values of two remaining color channels of the image sensor used (in the above example blue B and green G), while the second video data stream is extracted/separated from the original video data stream on the basis of signal values of a first color channel (in the above example: red) of the image sensor, which differs from the two remaining color channels. This first color channel can thus be the remaining color channel, since the rest of the color channels are evaluated for the WLI imaging.

In the separation of the first video data stream (which is to visualize, for example, the WLI component), however, the effect generated by the spectrally limited light (in the above example said fluorescent light image component “FI_{(x,y)}”) is also taken into consideration here, as can be seen on the basis of the formula for the gray value “Gray1”. It can furthermore be seen that in the generation of the first video data stream in the above example, all three color channels of the image sensor are taken into consideration in the calculation of the signal value Gray1_{(x,y)}. That is to say, the first video data stream is based on signals of all color channels of the image sensor used (a color channel can be understood, for example in an RGB sensor, as the sum of all signals of pixels which have the same color filter. All red pixels are thus part of the red color channel, and all blue pixels are part of the blue color channel, for example).

The information with respect to the effect generated by the spectrally limited light/the fluorescent light image component is therefore not lost in the first video data stream, but rather is also taken into consideration there in the image processing/the generation of the first video data stream. Conversely, however, this also applies to the second generated video data stream, because due to the consideration of the local dynamic range, all color channels of the image sensor are also taken into consideration here for the calculation of individual pixels. This represents a significant difference of the approach according to the invention from spectral imaging with the aid of a hyperspectral image sensor, in which an NIR fluorescent light wavelength is only sensorially acquired using additional NIR pixels, and not using the other pixels, meaning that the separation there is a spatial separation based on the pixels/color channels of the sensor.

The specification (x,y) is to indicate here that these steps can obviously be applied (depending on the desired resolution) for different pixels or for different local image areas (in particular even after a debayering!) within an image from the original video data stream, in order to thus be able to separate the respective image signal components in a location-resolved manner. In a pixel-by-pixel calculation, (x,y) would therefore designate the (image) position of each individual pixel in the image and a respective calculation would then be carried out for each pixel in order to obtain a respective calculation result in a location-resolved manner for each pixel.

Alternatively, such a “color background”, which is based on the visible illumination light, can also be calculated directly from signals of the color channels, for example using the following formula:

R_out_{(x,y)}=Gray1_{(x,y)}

G_out_{(x,y)}=Gray1_{(x,y)}

B_out_{(x,y)}=Gray1_{(x,y)}

However, it can also be provided that a gray background is not generated within the first video data stream, but rather a color background of the recorded video data stream, which is ascertained, however, by offset of the already previously calculated fluorescent light image signal FI_{(x,y)}. This can be achieved, for example, by the following formula, wherein the calculated color signal values R_out, G_out, and B_out define the color output image of the first video data stream, which is calculated from the recorded original video data stream (which is defined by the color signal values R_out, G_out, and B_out) in consideration of the already calculated FI signal FI_{(x,y)}:

$${R\_out}_{( x , y )} = {R\_in}_{( x , y )} - Rate 2\_r \times {FI}_{( x , y )}$$

$${G\_out}_{( x , y )} = {G\_in}_{( x , y )} - Rate 2\_g \times {FI}_{( x , y )}$$

$${B\_out}_{( x , y )} = {B\_in}_{( x , y )} - Rate 2\_b \times {FI}_{( x , y )}$$

In this case, the correction coefficients Rate2_r, Rate2_g, and Rate2_b specify respective weightings by which the fluorescent light image signal FI_{(x,y)} is multiplied in order to calculate out its component on the respective signal of the respective color channel R/G/B. The correction coefficient Rate2 can result, for example, from the residual sensitivity of the color channels of the image sensor used in relation to the fluorescence signal.

In other words, the correction factor Rate2 therefore specifies the component of the FI signal which, in particular in relation to IR light, is not part of the (typically visible) illumination light component (R_out, G_out, and B_out) and is therefore to be subtracted from the original color signal values (R_in, G_in, B_in).

Furthermore, it can be provided, for example, that an extraction/separation of a fluorescent light image from the recorded video data stream is implemented by the filter provision. This can take place in particular using a color matrix as illustrated below on the basis of the formula. In this case, for example for each pixel, an FI signal “FI_{(x,y)_out}” can be calculated by an extracted FI base signal (in the example below: ((CSMa_41*R_in_{(x,y)}*(Rate3_r2*Max1_{(x,y)}−Rate3_r2*Min1_{(x,y)}))), with or without additional color components (R/G/B), being calculated using color matrix coefficients (CSMa_4i) from the original signals (R/B/G_in_{(x,y)}) of the color channels of the image sensor. This can be carried out for example by the following formula:

$$\begin{matrix}{FI}_{( x , y ) out} = ( ( CSMa\_ 41 * {R\_in}_{( x , y )} * ( Rate3\_r2 * ( Max {1}_{( x , y )} - Min {1}_{( x , y )} ) ) \\ + ( CSMa\_ 42 * {G\_in}_{( x , y )} * ( Rate3\_g2 * ( Max {1}_{( x , y )} - Min {1}_{( x , y )} ) ) \\ + ( CSMa\_ 43 * {B\_in}_{( x , y )} * ( Rate3\_b2 * ( Max {1}_{( x , y )} - Min {1}_{( x , y )} ) ) \\ + ( CSMa\_ 44 * {IR\_in}_{( x , y )} * ( Rate3\_i2 * ( Max {1}_{( x , y )} - Min {1}_{( x , y )} ) ) )\end{matrix}$$

A separation of a fluorescent light image from the recorded video data stream, in particular using a color matrix, can therefore be implemented by the filter provision. In this case, an FI signal (which defines the fluorescent light image) can preferably be calculated in consideration of a local dynamic range (max-min) (in particular the one previously explained in detail) from all color channels (R/G/B/IR) of the image sensor. Additionally, the local dynamic range (max-min) can be weighted differently in each case per color channel with the aid of a respective correction coefficient Rate3. In this approach, the FI signal is therefore calculated as a combination of the respective original color component in consideration of the local dynamic range (max-min). The respective different weighting Rate3 ensures here that the respective FI signal can be calculated even more precisely from all color channels.

Due to the incomplete separation of the color components in the Bayer color filters of the pixels of the (color) image sensor used, interference signal components are known to result. These interference signal components can be removed with the aid of the respective correction coefficient Rate3_r2, Rate3_g2, Rate3_b2, and Rate3_i2 and/or by means of the respective CSMa_xx parameter. The selection of the respective correction coefficient Rate3 therefore enables even more accurate adaptation due to an even more flexible form of the subtraction of individual components of the original signal component of the respective color channel (R/G/B/IR). Therefore, in particular the CSMa_xx parameters are suitable for removing the described interference signals.

The precise selection of the correction coefficients Rate1, Rate2, and Rate3 explained so far is dependent on the spectral sensitivity curve of the image sensor used and the emission spectrum of the fluorescent light. The separation of the original video data stream can be optimally adapted to the image sensor used by the selection of the parameters Rate1, Rate2, Rate3. It is also possible to dynamically adapt such correction coefficients. This is in particular of interest for visualization systems on the basis of HDR image sensors or for visualization systems which are designed for the sensorial acquisition of at least two different spectrally limited lights, in particular of at least two different spectral fluorescent light ranges. This is because in this way the separation can be adapted correctly to the situation in each case, for example if a change of the fluorophore to be visualized in the application takes place.

The indicated possibility of adapting these parameters dynamically was intended for further generalization and as a supplement for future systems such as systems having HDR sensors or for systems which are to cover more than one fluorescence range.

In the above example, a total of four color channels R, G, B, IR are taken into consideration in the calculation of the FI signal, as can be seen on the basis of the formula. Such a case can occur, for example, upon use of a camera head/an image recording device which has two image sensors (for example, RGB color image sensor+monochromatic sensor for the IR channel), or if a chronologically alternating illumination is used. In the case of an alternating illumination, signals of an IR channel can also be recorded at specific times if only one image sensor is used (in this case, IR light is acquired using all 3 channels R/G/B of the single color image sensor) and at times deviating therefrom signals of the three R/G/B color channels using the same image sensor. In other words, in a method according to the invention, more than 3 color channels can also be taken into consideration, even if the color image sensor used fundamentally only has three color channels R/G/B.

Alternatively thereto, for example, a color image sensor having four color channels R/G/B/IR can also be used, however. In this case, an alternating illumination does not necessarily have to be used. The FI signal, which represents a fluorescent light image component, can still be calculated in such a case with the aid of the method according to the invention in consideration of all four color channels (for example, using the above formula), however.

On the basis of the extraction of the FI signal, two final signals can be generated for a user, for example, from the recorded video data stream: A visible image background (defined by R_out_{(x,y)}, G_out_{(x,y)}, B_out_{(x,y)}) and, for example, a fluorescence image (defined by FI_{(x,y)_out}). It is advantageous in this case for good visibility if the fluorescent light areas are amplified in relation to the image background, which can be ensured by the filter provision. Furthermore, it can be advantageous that the two final image signals can be used, for example, as if they came from two different sensors or from a time-multiplex processing of sensor signals (as in the case of a temporal separation). It is accordingly furthermore advantageous that the respective final signals generated by the filter provision can be generated continuously in the respective first or second video data stream, so that two live video image data streams can be generated to visualize the visible image background and the fluorescent light image component.

In a further advantageous embodiment, it can be provided that the first video data stream and/or the second video data stream each comprise unsegmented images, i.e. images which each show the complete scene and which are acquired using an imaging optical unit of the visualization system used. The image segmentations often carried out in the prior art result in a hard/digital decision about which signal components are retained and which are discarded (for example only white light or only FI), which often results in a loss of image information. In the approach according to the invention, in contrast, textures and details which are based for example on white light and are sensorially acquired using the image sensor in a specific image region can be retained in the first video data stream and at the same time FI signal components from the same image region can be retained in the second video data stream. In other words, all of the image information can be retained by the approach according to the invention.

It is particularly advantageous in this case if image information of the recorded video data stream is retained unchanged due to the unsegmented image processing of the first and/or second video data stream. It is furthermore advantageous that image information of the recorded video data stream does remain unchanged, but, for example, fluorescent light areas of the recorded video data stream can be processed separately, for example with the aid of a “color enhancement”. Unsegmented processing of the recorded video data stream can therefore particularly advantageously be implemented, so that no image information is lost.

Alternatively or additionally, it can be provided that the first and/or the second video data stream correlate (in particular in each pixel) with changes in the recorded (original) video data stream. Changes in the recorded video data stream can be caused here, for example, by changes of the spectrally limited light, which in turn results, for example, in a change of the effect that can be generated by the spectrally limited light.

Changes in the recorded video data stream are therefore, for example, visualized directly by the first and/or second video data stream. It is furthermore additionally advantageous that the changes of the recorded video data stream can be displayed directly to a user in this manner, without a time delay.

The first and/or the second video data stream thus preferably correlates with changes of the recorded video data stream, and specifically continuously and/or without steps (in each case) in each pixel of the image sensor. In other words, information from the individual pixels and color channels of the original recorded video data stream is therefore incorporated into each of the two generated video data streams.

The filter provision can thus in particular be configured such that the first video data stream and the second video data stream are correlated with one another.

In a further advantageous embodiment, it can be provided that the first video data stream and the second video data stream are generated simultaneously and/or independently of one another. This results in rapid image processing of the recorded video data stream in two parallel image processing paths. It can thus be provided that the first video data stream is generated by means of a first image processing path and that the second video data stream is generated by means of a second separate image processing path. It is therefore possible, for example, to generate a white light image of the recorded video data stream by means of the first video data stream and at the same time to separate a fluorescence image from the recorded video data stream by means of the second video data stream. In this manner, a direct comparison between fluorescence image and white light image can take place and/or a direct overlay (image overlay) of the two video data streams can be implemented.

By means of the two parallel image processing paths, for example, different image signal processing steps can be applied to the original recorded video data stream simultaneously to one another and/or independently of one another.

Depending on the application, the spectrally limited light can have, for example, a spectral bandwidth (FWHM) of less than 100 nm, wherein multiple different emission peaks respectively having such a bandwidth can also be sensorially acquired as a fluorescent light image signal and separated by means of the method according to the invention. The spectrally limited light can moreover—for example depending on the fluorophore used—lie inside or outside the visible wavelength range. Therefore, for example fluorescent light areas in the observed scene can advantageously be made better visible and can be processed separately for this purpose accordingly.

In a further advantageous embodiment, it can be provided that the first video data stream codes a stream of white light images. The entire recorded video data stream can therefore particularly advantageously be processed, for example, without representing an effect generated by the spectrally limited light with highlighting. A processed grayscale image or a color image can be generated for example from the recorded video data stream by the first white light image data stream.

In a further advantageous embodiment, it can be provided that the second video data stream codes a stream of spectral images, in particular in false color representation (for example generated by means of a digital color enhancement).

Therefore, for example, the effect generated by the spectrally limited light, for example fluorescent light areas, of the recorded video data stream can particularly advantageously be highlighted in color.

In a further advantageous embodiment, it can be provided that the first video data stream and the second video data stream are simultaneously displayed jointly on a monitor after the processing, in particular adjacent to one another or in the form of a synthetic image (for example in the form of a transparent overlay=image overlay). Accordingly, both video data streams can be combined with one another particularly advantageously, for example, such that a complete monitor image results from the first and the second video data stream.

Alternatively, it can be provided, for example, that the first video data stream is displayed on one monitor and the second video data stream is displayed on a further monitor. Fluorescent light areas can thus be observed by a user separately and/or for example in relation to the entire recorded video data stream. Furthermore, it is advantageous that the correspondingly processed video data streams can be interpreted and/or evaluated by a display on the monitor.

In a further advantageous embodiment, it can be provided that the effect generated by the spectrally limited light is a fluorescent light image signal. In other words, the spectrally limited light can be a fluorescent light which is induced by an excitation light, in particular wherein the second video data stream visualizes/highlights the fluorescent light image signal. It can therefore particularly advantageously be recognized, for example, whether the recorded video data stream contains for example fluorescent light areas and/or how pronounced the fluorescent light areas are with respect to the entire recorded video data stream. These areas can thus be highlighted for a user, in particular by means of a false color representation (color enhancement).

In a further advantageous embodiment, it can be provided that the first and the second video data stream are generated using a single color image sensor, which preferably has at least three color channels (for example R/G/B or R/G/B/IR). It is particularly advantageous in this case that a good image resolution can be generated by color image sensors, these often being less expensive than other sensors. Furthermore, if only a single image sensor is used, it is consequently advantageous that for example more space is available within the visualization system. Moreover, it is advantageous that heat development, which necessarily occurs in particular due to power losses during the operation of the image sensors/the image sensor, can be significantly reduced by the use of a single image sensor in comparison to at least two image sensors.

In a further advantageous embodiment, it can be provided that at least one additional, in particular downstream, image signal processing is carried out on the first video data stream and/or on the second video data stream.

The additional image signal processing can be, for example, a reduction of an undesired smoke development in the recorded video data stream (“smoke reduction”), which can result, for example, due to an electric cutting device, for example upon sclerosis of blood vessels. The optical impression of the smoke in the image can be reduced by means of the image signal processing. Additionally or alternatively, the additional image signal processing can implement, for example, an improvement of the image representation (for example noise suppression (“noise reduction”), preferably as a general function in the white light image), a specific color representation of fluorescent light areas, and/or an adaptation of a color intensity distribution of the fluorescent light areas.

The recorded video data stream can therefore particularly advantageously be qualitatively evaluated by the first and/or the second video data stream, for example, and/or different image information of the recorded video data stream can be processed separately.

Furthermore, noise suppression algorithms, for example, can be applied to both video data streams, but each having a different expression or strength of the noise suppression. It can therefore be provided that each of the two video data streams is subjected to a respective different (i.e. matched to the respective video data stream) downstream image processing, in particular a respective matched noise suppression, in order to thus generate a post-processed first and a post-processed second video data stream. Image processing methods are available for this purpose in the prior art, which permit the noise within a recorded image to be assessed. Moreover, there can also be further indications depending on the exposure control, for example: Depending on how dark the image is, certain parameters of the image sensor can be actively adapted (e.g. longer exposure time, higher electronic gain, etc.). Since a higher gain produces more noise, for example, such parameters can also be incorporated into the assessment of the noise. Since noise is a statistically random (interference) signal, it does not have a causal relationship to the fluorescent signal.

Finally, the two video data streams, in particular the two post-processed video data streams, can be subjected to a downstream augmented image processing (advanced imaging/advanced video processing), in order to generate augmented image information in the form of an augmented video data stream (advanced video stream). Such an augmented video data stream can consist, for example, of a superposition of the FI signal with a white light background image.

Alternatively or additionally, the features of the additional independent claim, directed to an image recording method for generating a video data stream using a sensor, in particular an image sensor, are provided in order to achieve the stated object according to the invention. In particular, in order to achieve the stated object, it is therefore proposed according to the invention that the effect generated by the spectrally limited light is recorded by the sensor and converted into an original video data stream, which is then processed using an image processing method according to the invention.

It can be provided here, for example, that the sensor is a color image sensor, in particular an RGB sensor.

The spectrally limited light can be, for example, a fluorescent light, which preferably characterizes a fluorescent light area. The effect that can be generated by the spectrally limited light can therefore, for example, advantageously be a representation of fluorescent light areas of the recorded video data stream.

In a further advantageous embodiment, it can be provided that an emission of the spectrally limited light is excited by an irradiation of an object to be visualized using an excitation light. For example, it can moreover be provided that the excitation light is used combined with a white light as illumination light.

Alternatively or additionally, the features of the additional independent claim, directed to a video data stream generation stage are provided in order to achieve the stated object according to the invention. The video data stream generation stage can include a processor configured here to carry out the image processing method and/or the method for generating a video data stream as are each previously described and/or claimed here. In particular, in order to achieve the stated object, it is therefore proposed according to the invention that the video data stream generation stage is configured to generate, from a video data stream recorded by a sensor, in particular an image sensor as explained above, a first video data stream, in which an effect generated by a spectrally limited light is reduced in relation to an image background, and that a second video data stream can be generated from the recorded video data stream by means of the video data stream generation stage, in which the effect generated by the spectrally limited light is amplified in relation to the image background. The image processing method according to the invention and/or the method for generating a video data stream and the respective advantages mentioned in the methods can thus particularly advantageously be implemented using this device.

In a further advantageous embodiment, it can be provided that the sensor is a color image sensor, in particular an RGB sensor. It is particularly advantageous here that a good image resolution of the recorded video data stream can be implemented at comparatively low cost by RGB sensors.

In a further advantageous embodiment, it can be provided that the device is designed having a camera, a camera control unit, which is configured for an application of the filter provision to the recorded video data stream, and having at least one monitor.

The recorded video data stream can particularly advantageously be processed in an unsegmented manner in the first and/or the second video data stream, for example, due to the filter provision. Furthermore, the processed video data streams can advantageously be displayed for example on one or more monitors. It can therefore advantageously be implemented, for example, that the processed video data streams can be displayed as an overlay display, as a picture-in-picture display, and/or as a split-screen display, for example, on a monitor.

Alternatively or additionally, one or more of the features disclosed herein directed to a visualization system are provided to solve the mentioned object. This visualization system can in particular comprise an endoscope or a microscope or an exoscope. The visualization system furthermore has a color image sensor, which has multiple color channels (R, G, B; preferably at least three color channels), and an image processor for processing a video data stream recorded using the image sensor. In order to achieve the stated object, it is proposed according to the invention that the image processor is configured to carry out a method as described above or claimed here. In particular, an image recording method as described above can be carried out using this visualization system.

### BRIEF DESCRIPTION OF THE DRAWINGS

The invention will now be described in more detail on the basis of exemplary embodiments, but is not restricted to the exemplary embodiments. Further exemplary embodiments result by combination of the features of individual or multiple claims with one another and/or with individual or multiple features of the exemplary embodiment.

In a very simplified manner

FIG. 1 shows a schematic two-dimensional representation of a device having a monitor for carrying out an image processing method and for generating a video data stream generation stage,

FIG. 2 shows a schematic representation of the method steps of an image processing method,

FIG. 3 shows a schematic representation of method steps of an image processing method in a flow chart,

FIG. 4 shows a schematic two-dimensional representation of a device according to FIG. 1 having two monitors,

FIG. 5 shows a schematic representation of method steps of an image processing method in a flow chart according to FIG. 3 having two monitors, and

FIG. 6 shows a two-dimensional diagram to represent various wavelength ranges of the visible and spectrally limited light.

### DETAILED DESCRIPTION

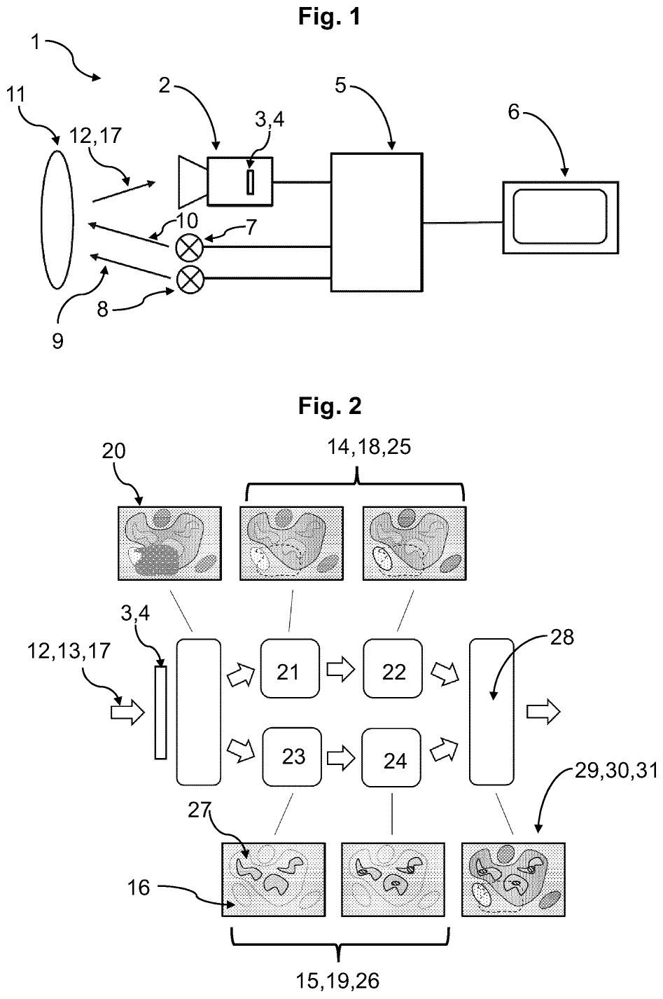

FIG. 1 shows a digital video data stream generation stage, identified as a whole by 1, which is intended to carry out an image processing method and a method for generating a video data stream.

The device 1 is designed as part of a medical visualization system, the latter comprising a camera 2 having a sensor 3, in this exemplary embodiment an RGB color image sensor 4 having three separate color channels (R, G, B), a camera control unit (CCU) 5 having an image processor 43, a monitor 6, and two light sources 7, 8. The image processor 43 is configured to apply a filter provision to a video data stream recorded by the camera 2. Furthermore, it can be seen that the camera 2 is connected to the RGB image sensor 4 and the two light sources 7, 8 are connected to the camera control unit 5 and are controlled thereby.

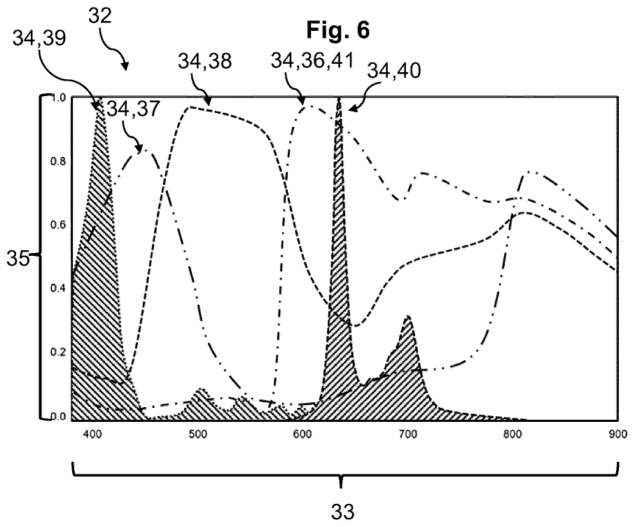

In this exemplary embodiment, a light source 8 emits a white light 9, thus broadband visible wavelengths, and the other light source 7 emits an excitation light 10. The excitation light 10 in this exemplary embodiment is a nonvisible UV light (cf. FIG. 6), but depending on the application could also be in the visible (for example blue) wavelength range.

The excitation light 10 and the white light 9 simultaneously irradiate an object 11, which contains a specific chemical, in this exemplary embodiment an amino acid (5-aminolevulinic acid “5-ALA”), which in turn interacts with the emitted white light 9 and with the excitation light 10. The interaction with the excitation light 10 in turn results in an emission of a spectrally limited light 12, in this case a red fluorescent light 13, which is in the visible spectral range and results in a narrow band, namely having a full width at half maximum of less than 100 nm. It can therefore be stated that the spectrally limited light 12 is excited by an irradiation of the object, more precisely the fluorophore located therein, using an excitation light 10 for a spontaneous light emission, which is known per se.

An effect generated by the spectrally limited light 10 is then recorded/sensorially acquired by the sensor 4 of the camera 2, namely the emitted fluorescent light is spectrally acquired with the aid of the image sensor 4, in particular using its red color channel R.

A filter provision stored with respect to the spectrally limited light 12 is now applied to the (original) video data stream 42 recorded using the image sensor 4. The filter provision is thus designed for a specific application case, a specific fluorophore. Multiple such filter provisions can also be stored in the image processor 43, as a result of which the visualization system can be used in multiple applications each in the scope of a method according to the invention.

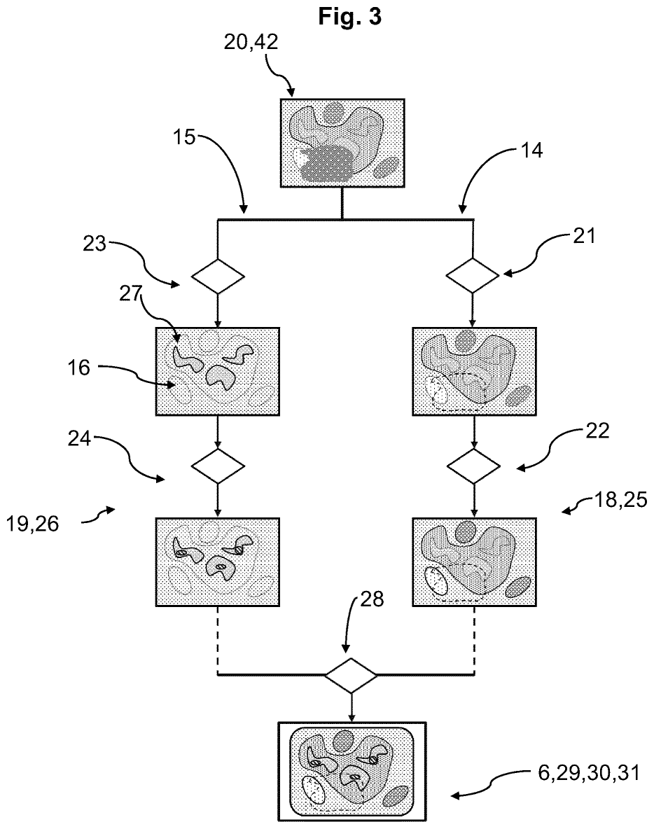

Using the filter provision and employing the described video data stream generation stage, a first video data stream 14 is generated from the recorded video data stream 42, in which the effect generated by the spectrally limited light 12, namely the fluorescent light image component FI, is reduced in relation to an image background 16, which corresponds to the signal component of the illumination light (cf. FIG. 2 and FIG. 5). Simultaneously thereto, independently of the first video data stream 14, a second video data stream 15 is generated from the originally recorded video data stream 42, in which the effect generated by the spectrally limited light 12, more precisely the fluorescent light image component, is amplified in relation to the image background 16 (cf. FIG. 2 and FIG. 5). FIGS. 3 and 5 illustrate here that two independent image processing paths 18, 19 are used in each case.

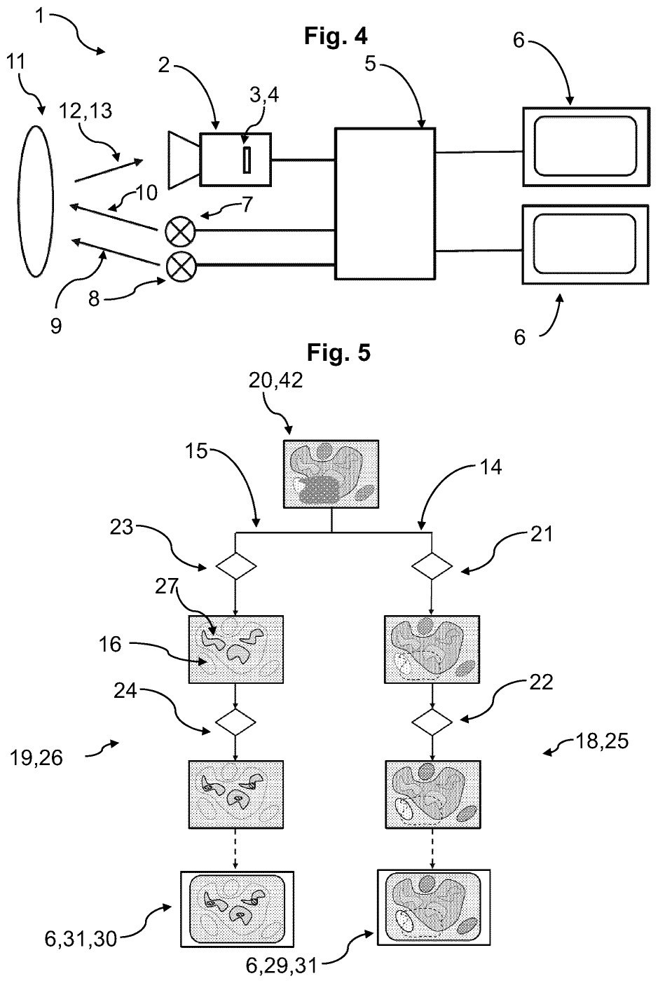

The processed video data streams 14, 15 can therefore be displayed via the monitor 6 of the visualization system 1. For example, the two generated video data streams 14, 15 can be shown simultaneously and adjacent to one another as shown in FIG. 4.

FIG. 2 shows a representation to illustrate the various method steps implementable by the device 1 of an image processing method according to the invention for processing the video data stream 42 recorded by the sensor 3 using the already described filter provision. Components and functional units which are functionally and/or structurally equivalent or identical to the preceding exemplary embodiment are identified by the same reference signs and are not described separately once again.

It can be seen that initially the light 17 reflected or emitted by the object 11 is incident on the RGB sensor 4 used in this exemplary embodiment. The video data stream 42 recorded in this case therefore primarily contains unprocessed image information 20. To then be able to process this unprocessed image information 20, a first video data stream 14, which forms a first image processing path 18, and a second video data stream 15, which in turn forms a second processing path 19, are generated by the filter provision. Both image processing paths 18, 19 are designed in this exemplary embodiment to apply in each case two different image signal processing steps to the unprocessed image information 20 of the recorded video data stream 42.

In this exemplary embodiment, the first video data stream 14 having the first image processing path 18 forms a white light data stream 25, thus a continuous stream of white light images, and the second video data stream 15 having the second image processing path 19 forms a spectral image data stream 26, thus a continuous stream of spectral images.

The unprocessed image information 20, more precisely the respective individual images of the recorded video data stream 42, are initially processed in this case in an unsegmented manner in the first image processing path 18 via a first image signal processing 21. In this exemplary embodiment, initially a “smoke reduction” is applied here to the respective individual images; such a special image filter can suppress undesired image components, in the example a smoke development observed in the image. A second image signal processing 22 subsequently takes place to improve the image representation of the individual images of the first video data stream 14.

Analogously thereto, the image information 20/individual images of the recorded original video data stream 42 are also initially processed in an unsegmented manner in the second image processing path 19. In this exemplary embodiment, the light 17 originating from the object 11 contains an emitted fluorescent light 13, as a result of which a representation or highlighting of the fluorescent light areas 27 (=fluorescent image areas in the respective individual image) of the recorded video data stream 42 takes place in a first image signal processing 23. It can therefore be stated that the effect generated by the spectrally limited light 12 is in this exemplary embodiment a visualization of a fluorescent light 13, more precisely of its fluorescent light image components, in the recorded video data stream 42.

Moreover, it can be seen that after the first image signal processing 23, a second image signal processing 24 of the second image processing path 19 takes place in order, for example, to highlight in color or make better visible for the user an intensity distribution of the fluorescent light areas 27 by means of a color palette of false colors (for example blue to yellow for fluorescent light which is actually red).

In a final step of the image processing method, in this exemplary embodiment a superposition 28 of the generated video data streams 14, 15 is carried out to form a new common video data stream (consisting of a series of superimposed images), by which a live monitor image 31 is generated, on which a white light image 29 and therein a fluorescent light image component 30 highlighted in false color are visualized.

FIG. 3 shows, in contrast to the preceding exemplary embodiment, a corresponding flow chart correlated with the described image processing method for the unsegmented processing of the recorded video data stream.

FIG. 4 shows a further device 1 according to the invention for carrying out an image processing method, wherein in contrast to FIG. 1, the processed video data streams 14, 15 are displayed on two monitors 6. In the exemplary embodiment, it is provided here that a first monitor 6 displays a white light image 29 and that a second monitor 6 displays a fluorescence image 30 of the recorded video data stream.

FIG. 5 shows the method steps of the or a further image processing method in a further flow chart, which can be implemented using a device 1 according to FIG. 4, wherein in contrast to the flow chart shown in FIG. 3, the processed video data streams 14, 15 are displayed on two monitors 6 according to FIG. 4.

FIG. 6 shows a diagram 32 having the various wavelengths 33 and wavelength ranges 34 acquired by the or an RGB image sensor 4 in nm in relation to a radiation intensity 35. The wavelength ranges of a red, green, and blue pixel 36, 37, 38, and also the wavelength ranges 34, 39, 40 of an excitation light 10, in this exemplary embodiment UV light, and of the spectrally limited light 12 are shown here. In this exemplary embodiment, the wavelength range 34 of the spectrally limited light 40 comprises the fluorescent light 13, excited by the excitation light 10, of the already mentioned or of an object 11, which in this exemplary embodiment contains the already mentioned amino acid 5-ALA.

Furthermore, it can also be seen that a wavelength range of the red pixel 36 overlaps with a wavelength range 40 of the fluorescent light 13 generated by the amino acid 5-ALA. In this range of the overlap, which takes place in a wavelength range 34 of 600-700 nm and a simultaneously high radiation intensity 35, these components are not acquired by the green and blue pixels of the sensor due to the low radiation intensity 35. Therefore, a fluorescent light area 27 is primarily acquired with the aid of the red pixels 41 by the RGB image sensor 4.

The filter provision can therefore be determined via an algorithm, for example the algorithm described herein and/or an algorithm based thereon, such that various wavelength ranges 34 of the recorded video data stream 42 are filtered in an unsegmented manner in the first and second video data stream 14, 15 (cf. FIGS. 2, 3, 5). It is therefore provided in this exemplary embodiment that due to the filter provision of the second video data stream 15, the fluorescent light areas 27 acquired by the red pixels 41 are processed and these are amplified in relation to the image background 16. Simultaneously thereto, in the first video data stream 14, the image information 20 of the recorded video data stream is processed without the fluorescent light areas 27 being highlighted in relation to the image background 16. It can therefore be stated that the effect generated by the spectrally limited light 12, in this exemplary embodiment acquired by a respective one or the red pixels 41, is reduced in relation to the image background 16 in the first video data stream 14, and that the generated effect is amplified in relation to the image background 16 in the second video data stream 15.

### LIST OF REFERENCE NUMERALS

1 visualization system, including digital video data stream generation stage
2 camera
3 sensor
4 RGB image sensor
5 camera control unit
6 monitor
7 light source
8 light source
9 white light
10 excitation light
11 object
12 spectrally limited light
13 fluorescent light
14 first video data stream
15 second video data stream
16 image background
17 (from 11) reflected or emitted light
18 first image processing path
19 second image processing path
20 image information
21 first image signal processing of the first video data stream
22 second image signal processing of the first video data stream
23 first image signal processing of the second video data stream
24 second image signal processing of the second video data stream
25 white light data stream
26 spectral image data stream
27 fluorescent light area
28 superposition
29 white light image
30 fluorescence image
31 monitor image
32 diagram
33 wavelength
34 wavelength range
35 radiation intensity
36 wavelength range of red pixels
37 wavelength range of blue pixels
38 wavelength range of green pixels
39 wavelength range of excitation light
40 wavelength range of spectrally limited light
41 red pixels
42 original video data stream
43 image processor

1. An image processing method for processing a video data stream (42) recorded by a sensor (3), the method comprising:
storing a filter provision applicable to the video data stream (42) with respect to a spectrally limited light;
generating a first video data stream (14), in which an effect generated by the spectrally limited light (12) is reduced in relation to an image background, using the filter provision from the recorded video data stream (42); and
generating a second video data stream (15), in which the effect generated by the spectrally limited light (12) is amplified in relation to the image background, from the recorded video data stream (42) using the filter provision.

2. The image processing method according to claim 1, further comprising
based on the filter provision, by image processing of the originally recorded video data stream (42), deriving the first video data stream (14), which visualizes the original video data stream as if an excitation light were switched off, and deriving the second video data stream (15), which visualizes an effect of the excitation light.

3. The image processing method as claimed in claim 1, wherein the sensor (3) is a color image sensor (4) having multiple color channels (R, G, B) and all of the color channels of the color image sensor (4) are taken into consideration both in the generating of the first video data stream (14) and in the generating of the second video data stream (15).

4. The image processing method as claimed in claim 3, further comprising at least one of a) separating the first and second video data streams (14, 15) in a location-resolved manner based on a respective local dynamic range (max-min), which is ascertained in a location-resolved manner from the original video data stream (42) considering signal values of all of the color channels of the image sensor (4); or
b) in the generating of the second video data stream (15), calculating the effect generated by the spectrally limited light (12) in each case in a location-resolved manner from signal values of a single one of the color channels (R/G/B) of the image sensor (4).

5. The image processing method as claimed in claim 3, further comprising implementing a separation of a fluorescent light image from the recorded video data stream (42) by the filter provision, in which an FI signal is calculated in consideration of a local dynamic range (max-min) from all of the color channels (R/G/B/IR) of the image sensor (4), and weighting the local dynamic range (max-min) differently in each case per color channel using a respective correction coefficient Rate3.

6. The image processing method as claimed in claim 3, further comprising a) separating the first video data stream (14) based on signal values of two remaining ones of the color channels (R/B/G) of the image sensor (4) used from the original video data stream (42), and separating the second video data stream based on signal values of a first one of the color channels (R/G/B) of the image sensor (4), which differs from the two remaining of the color channels (R/B/G), from the original video data stream (42), or
b) separating the first video data stream (14) based on the signal values of all of the color channels (R/B/G) of the image sensor (4) used from the original video data stream (42) and a previously calculated fluorescent light image signal FI_{(x,y)}, taking into consideration an individual weighting for each said color channel (R/G/B) with the aid of a respective correction coefficient Rate2.

7. The image processing method as claimed in claim 1, wherein at least one of a) the first video data stream and/or the second video data stream each comprise unsegmented images, or
b) the first video data stream (14) and the second video data stream (15) each correlate in each pixel with changes in the recorded video data stream (42).

8. The image processing method as claimed in claim 1, wherein at least one of a) the filter provision is configured such that the first video data stream and the second video data stream are correlated with one another, or
b) the first video data stream and the second video data stream are generated at least one of simultaneously or independently of one another.

9. The image processing method as claimed in claim 1, wherein the first video data stream is generated by a first image processing path and the second video data stream is generated by a second separate image processing path.

10. The image processing method as claimed in claim 1, wherein the spectrally limited light at least one of has a spectral bandwidth (FWHM) of less than 100 nm or lies inside the visible wavelength range.

11. The image processing method as claimed in claim 1, wherein at least one of a) the first video data stream codes a stream of white light images, or
b) the second video data stream codes a stream of spectral images.

12. The image processing method as claimed in claim 1, wherein the first video data stream and the second video data stream are displayed simultaneously after the processing, adjacent to one another or as a synthetic image comprising a partially transparent superposition, jointly, on a monitor.

13. The image processing method as claimed in claim 1, wherein at least one of a) an effect generated by the spectrally limited light is a fluorescent light image signal, or
b) the spectrally limited light is a fluorescent light induced by an excitation light, and the second video data stream visualizes the fluorescent light image signal.

14. The image processing method as claimed in claim 1, wherein the first and the second video data stream are generated using the sensor comprises a single color image sensor, and the color image sensor has at least three color channels (RGB).

15. The image processing method as claimed in claim 1, further comprising carrying out at least one downstream image signal processing on at least one of the first video data stream or the second video data stream.

16. An image recording method for generating a video data stream using a sensor (3), the method comprising:
recording an effect generated by the spectrally limited light (12) with the sensor (3) and converting the recorded spectrally limited light into an original video data stream (42), and subsequently processing the original video data stream (42) using the image processing method as claimed in claim 1.

17. The method as claimed in claim 16, further comprising exciting a spontaneous emission of the spectrally limited light (12) by an irradiation of an object (11) to be visualized using an excitation light (10).

18. A video data stream generation stage, which is configured to carry out an image processing method as claimed in claim 1, wherein
the video data stream generation stage includes a processor configured to generate the first video data stream (14), in which an effect generated by the spectrally limited light (12) is reduced in relation to an image background, from the video data stream (42) recorded by the sensor (3), and the second video data stream (15), in which the effect generated by the spectrally limited light (12) is amplified in relation to the image background, is adapted to be generated from the recorded video data stream (42) by the video data stream generation stage.

19. The video data stream generation stage as claimed in claim 18, further comprising a camera (2), a camera control unit (5), which is configured for an application of the filter provision to the recorded video data stream (42), and at least one monitor (6).

20. A visualization system (43), comprising:
a color image sensor (4), which has multiple color channels (R, G, B);
an image processor (43) for processing a video data stream (42) recorded using the image sensor (4); and
the image processor (43) is configured to store a filter provision applicable to the video data stream (42) with respect to a spectrally limited light, generate a first video data stream (14), in which an effect generated by the spectrally limited light (12) is reduced in relation to an image background, using the filter provision from the recorded video data stream (42); and generate a second video data stream (15), in which the effect generated by the spectrally limited light (12) is amplified in relation to the image background, from the recorded video data stream (42) using the filter provision.
